(19) United States
(12) Patent Application Publication
(10) Pub. No.: US 2013/0105688 A1
(43) Pub. Date: May 2, 2013

(54) Method of Characterizing a Crystalline Specimen by Ion or Atom Scattering

(71) Applicant: Denis Jalabert, Grenoble (FR)

(72) Inventor: Denis Jalabert, Grenoble (FR)

(73) Assignee: COMMISSARIAT A L'ENERGIE ATOMIQUE ET AUX ENERGIES ALTERNATIVES, Paris (FR)

(21) Appl. No.: 13/635,826

(22) PCT Filed: Mar. 17, 2011
(86) PCT No.: PCT/IB11/51119

§ 371 Date: Nov. 30, 2012

(30) Foreign Application Priority Data
Mar. 19, 2010 (FR) 1001097

(51) Int. Cl. G01N 23/20

(52) U.S. Cl. CPC G01N 23/20
USPC 250/307

(57) ABSTRACT

Method of characterizing a crystalline specimen (E), characterized in that it comprises the steps consisting in: a) directing a substantially mono-energetic beam (F1) of projectiles chosen from atoms and ions onto a surface, called the top surface, of said specimen, the direction of propagation of said beam being characterized by an angle of incidence (θᵢ) and by what is called an azimuthal angle (φ) measured in the plane of said surface, the energy of said projectiles being equal to or greater than 50 keV; b) the projectiles scattered by the specimen are filtered in terms of energy, those of said projectiles that are scattered with a defined energy are detected and their scattering angle (θ_{d}), defined in a plane perpendicular to said top surface of the specimen, is measured; c) steps a) and b) are repeated for a number of different values of said azimuthal angle; and d) an image representative of the number of detected projectiles as a function of the scattering angle and of said azimuthal angle is constructed. Computer program product specifically designed for implementing such a method.

The invention relates to a method of characterizing a crystalline specimen using ion or atom scattering. More particularly, the invention makes it possible to characterize thin specimens, having a thickness of less than or equal to 1 μm and preferably in the nanometric range. The method of the invention principally uses light ions (H⁺, He⁺) of medium energy (from 50 or 100 keV to several MeV).

The method of the invention applies in particular, but not exclusively, to the characterizing of nano-objects (nanoparticles, quantum dots, nanowires or quantum wires, quantum wells . . . ) or electronic or optoelectronic devices comprising such nano-objects.

When a nano-object is deposited on a surface of a substrate or is englobed in a matrix, it is subject to mechanical stresses which induce deformations, which in their turn have an effect on its electronic and/or optical properties. This same thing occurs when a thin layer is deposited on a surface of a substrate. It is therefore necessary to measure, or at least to detect, these deformations.

The most conventional methods of characterizing a crystalline structure are based on the diffraction of X-rays or of particles such as electrons or neutrons. In principle, these techniques do not make it possible to observe the atomic structure of the specimen in real space, but only in reciprocal space: in fact the diffraction pattern is closely related to the Fourier transform of the studied structure. From the mathematical properties of the Fourier transform it results that the smaller the size (and in particular the thickness) of the observed object is, the weaker and wider are the diffraction peaks. Consequently, these methods are intrinsically unsuitable for characterizing nano-objects and thin layers.

The Medium Energy Ion Scattering (MEIS) technique for measuring deformation makes it possible to obtain structural data on crystalline nanostructures without encountering the intrinsic limitations of the techniques based on diffraction. This technique is described for example in the articles [1-5].

The principle of this technique is as follows. A collimated beam of ions of medium energy (of the order of 100 keV) is directed towards a specimen to be studied. The incident ions are back-scattered by the atoms of the crystalline network of said specimen, over a wide range of scattering angles and with different energies.

To a first approximation, the energy of each ion depends on the depth under the surface of the specimen at which it has been scattered. In fact, in order to be able to be scattered by a “deep” atom, an ion must travel a distance of several tens of nanometers inside the specimen; it therefore loses a significant part of its energy by excitation of volume plasmons in the crystal. On the contrary, the ions scattered close to the surface lose only a small fraction of their energy. Consequently, energy filtering of the scattered ions makes it possible to select those which have been scattered at a same depth.

If a diagram representing the number of ions of a specific energy as a function of their scattering angle is plotted, it is possible to observe one or more minima. It is possible to show that these minima correspond to principal directions of the crystalline network of the specimen. In fact, when an ion is scattered along a principal direction of the network, it necessarily intercepts another atom of said network, which deflects it. The minima of the scattering diagram are therefore due to the “shadow” of the atoms aligned along the principal directions.

This technique is not very accurate; in particular it does not make it possible to detect the rotations of the crystalline network in all directions in space. Moreover, it makes it possible to reveal deformations of the crystalline structure of a nano-object only on condition of having a reference measurement, carried out in the substrate. This is not however always possible, in particular in the case of a complex specimen comprising a stack of several layers, or an amorphous substrate or one amorphized after heat treatment or implantation.

The documents [6-8] describe a three-dimensional medium energy ion scattering technique (3D-MEIS) which, contrary to the conventional “MEIS” technique, makes it possible to determine the three-dimensional crystalline structure of a specimen. This technique uses a bidimensional detector to create an image of the scattered ions. The energy filtering, which would destroy any spatial information in the azimuthal direction, is replaced by a measurement of the flight time of the ions, which are directed towards the specimen in the form of a pulsed beam. The energy resolution, and therefore the depth resolution, is significantly worse (by about a factor of 10) in comparison with the conventional “MEIS” technique.

The invention aims to provide a method of characterizing a crystalline specimen not having the aforesaid disadvantages of the prior art. More particularly, the invention aims to provide a method allowing a three-dimensional reconstruction of the crystalline structure of a specimen—which the conventional “MEIS” technique cannot do—whilst having a better spatial resolution in depth than does the “3D-MEIS” technique.

According to the invention, such an objective is obtained by a method of characterizing a crystalline specimen, characterized in that it comprises the steps consisting in:

a. directing a substantially mono-energetic beam of projectiles chosen from atoms and ions onto a surface, called the top surface, of said specimen, the direction of propagation of said beam being characterized by an angle of incidence and by a so-called azimuthal angle measured in the plane of said surface, the energy of said projectiles being equal to or greater than 50 keV;

b. energy filtering the projectiles scattered by the specimen, detecting those of said projectiles that are scattered with a defined energy and measuring their scattering angle, defined in a plane perpendicular to said top surface of the specimen;

c. repeating steps a. and b. for a plurality of different values of said azimuthal angle; and

d. constructing an image representative of the number of detected projectiles as a function of the scattering angle and of said azimuthal angle.

The method can also comprise a step f. consisting in determining at least two crystalline directions of the specimen by analyzing said image and in detecting a deformation of the crystalline network of said specimen from a comparison between said crystalline directions.

Said steps a. to d. can be repeated for a plurality of different values of the ion scattering energy, a said image being constructed for each of said energy values. In this case, the method can also comprise a step f′. consisting in detecting a deformation of the crystalline network of said specimen from a comparison between said images corresponding to different energy values. Preferably, at least one of said energy values can correspond to the energy of the ions scattered by a substrate of said specimen.

The method of the invention differs from a known MEIS technique of the prior art at the level of acquisition of data and in the processing and use of that data.

Firstly, the method of the invention comprises the carrying out of several acquisitions of scattering diagrams for different values of azimuthal angle. On the contrary, the MEIS technique is used for a predetermined value of said azimuthal angle.

Secondly, the conventional MEIS technique comprises the comparison of several unidimensional scattering diagrams, corresponding to different energy values. On the contrary, the method of the invention comprises the production of bidimensional images, representative of a projection of the crystalline structure—in real space—onto a spherical surface. Optionally, several images corresponding to different scattering energies can be compared in order to reveal a variation of said crystalline structure as a function of depth. The series of images obtained by the method of the invention is much richer in information than is the series of scattering diagrams procured by the conventional MEIS technique.

In comparison with the “3D MEIS” technique, the use of energy filtering makes it possible to maintain good spatial resolution in depth. However, this energy filtering destroys all spatial resolution in the azimuthal direction and, because of this, makes the azimuthal scanning mentioned in step c. necessary.

According to different particular embodiments of the invention:
Said projectiles can be chosen among: H⁺ ions and He⁺ ions.
The energy of said projectiles can be greater than or equal to 100 keV.
The energy of said projectiles can be included between 50 keV and 10 MeV and preferably between 100 keV and 3.5 MeV.
Said step b. can comprise the detection of the projectiles scattered in a range of scattering angles of width greater than or equal to 10° and preferably greater than or equal to 20°.
Said step c. can comprise the repetition of steps a. and b. for a plurality of different values of said azimuthal angle, distributed over a range of width greater than or equal to 30°.
Said specimen can have a thickness of less than or equal to 1 μm, preferably less than or equal to 100 nm and even more preferably less than or equal to 20 nm. It can be deposited on a substrate of greater thickness. It can in particular be a layer, a stack of layers, a nano-object or a set of nano-objects.
Said specimen can comprise at least one quantum dot, quantum wire or quantum well on a substrate.
The method can also comprise a step of determination of a crystalline symmetry of said specimen by measuring the difference between the values of the azimuthal angle for which the number of detected projectiles is substantially zero for any scattering angle.

The invention also relates to a computer program product specifically designed for implementing a method such as described above.

Other features, details and advantages of the invention will emerge on reading the description given with reference to the appended drawings, given by way of example and in which:

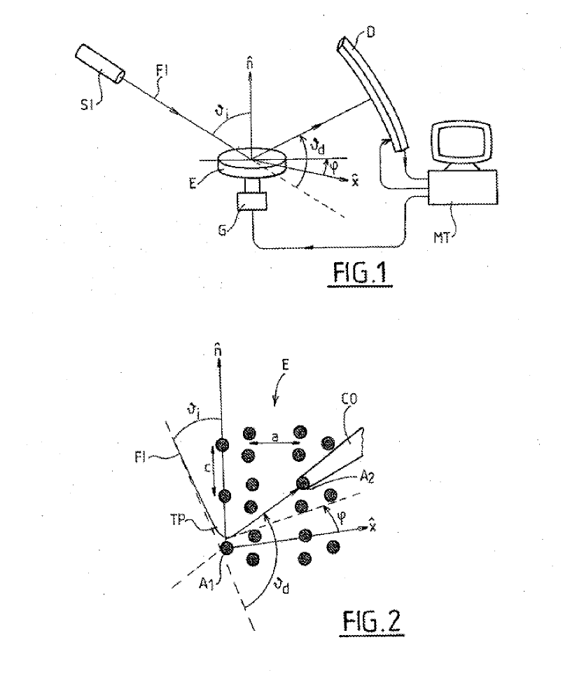

FIG. 1 shows a basic diagram of an assembly allowing the implementation of a method according to the invention;

FIG. 2 illustrates the principle of medium-energy ion scattering by a crystalline network;

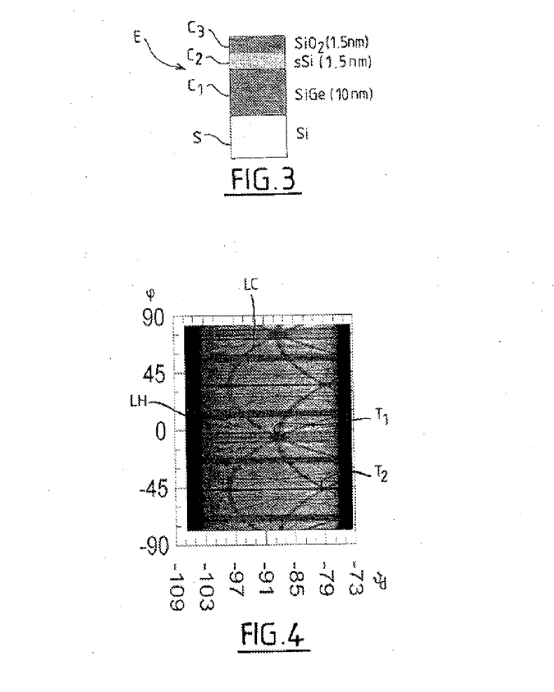

FIG. 3 is a diagrammatic representation of the structure of a specimen able to be studied by a method according to the invention; and

FIG. 4 shows an image acquired by a method according to the invention and representing the crystalline structure of the specimen shown in FIG. 3 at a specific depth.

FIG. 1 shows an experimental apparatus suitable for the implementation of the invention. This apparatus comprises:
a source of ions SI making it possible to direct a beam of medium-energy ions FI onto a surface of a specimen E;
a goniometer G which makes it possible to orient said specimen in space;
a detector D for detecting and energy filtering the ions scattered by the specimen.

The angle of incidence, measured between the direction of incidence of the beam FI and the normal \hat{n} to the surface of the specimen is indicated by θᵢ; the scattering angle of an ion, measured between the extension of the direction of incidence and the scattering direction is indicated by θ_{d}; and the azimuthal angle, measured in the plane of the surface of the specimen between the projection of the direction of scattering of an ion on said surface and a reference direction \hat{x} is indicated by φ.

The beam FI is preferably a beam of light medium-energy ions. The ions are preferably of the H⁺ and He⁺ type. The use of heavier chemical species is possible but not recommended. The use of chemical species that are too reactive (for example O⁺ or F⁺) is prohibited. The beam is substantially mono-energetic (energetic dispersion of the order of 0.1%) and collimated (divergence of the order of 0.1°). Even though the use of ions is the most natural choice, it is possible to use neutral atoms as projectiles; a beam of neutral atoms is generally obtained by neutralizing a beam of ions.

“Medium energy” is understood to be energy included between 50 keV (kiloelectronvolts; 1 keV=1.6×10⁻¹⁶ Joules) and a few MeV (megaelectronvolts), for example 10 MeV.

The use of higher energies can be envisaged, at least in principle, but at the cost of a loss of depth resolution (which is already 10 nm, that is about 40 atomic planes, for He⁺ ions at 2 MeV); on the other hand, the angular resolution becomes better as the energy of the ions becomes higher.

On the contrary, the use of projectiles having energy substantially less than 50 keV cannot be envisaged in the context of the invention, and this is so for several reasons:
Firstly, it is generally considered that the limit of 50 keV separates two different physical domains. Above 50 keV (the domain of the invention) it is possible to ignore physical atomic phenomena, which bring into play energies of a few tens of eV at most; it is therefore possible to study the scattering of ions by a conventional elastic Coulombian scattering model, in single collision condition (that is to say concerning the collision of an ion with a single nucleus of the specimen, which is the case of the detected ions). At lower energy, on the other hand, a larger number of physical phenomena come into effect (influence of the state of oxidation, of conductivity of the material, the Auger effect, etc.), and result in a degradation, or even destruction, of the specimen.
Secondly, the angular resolution obtained using low-energy ions is insufficient to allow a study of stresses in a specimen, which is the main objective of the method of the invention.
Finally, and above all, low-energy ions have too low a power of penetration of the specimen. Low-energy ions (1-25 keV) are used in a destructive surface characterizing technique, known as SARIS (Scattering and Recoiling Imaging Spectrometry). See articles [9, 10] in this respect.

In the source SI, the ions are created from neutral gas (for example He), ionized in a hollow cathode source by electron bombardment having an energy of about 100 eV and a current of 1.5 amps. The beam is sorted in mass by a magnetic sector and accelerated by an electrostatic voltage (with a precision of the order of 10⁻⁴). The beam is shaped by a series of Einzel lenses, a triple electrostatic quadripole and vertical and horizontal deflectors. The beam then passes into three diaphragms, each spaced by 1 m, in order to obtain a collimated beam. The residual vacuum in the accelerator and beam line assembly is of the order of 5×10⁻⁸ mbar.

The specimen E is placed on a goniometer G able to carry out rotations about three perpendicular axes with a precision of 0.02° and micrometric translations along the three directions in space. The specimen and the ion source and the detector D are placed in a vacuum of 10⁻¹⁰ mbar.

The angle of incidence θᵢ is chosen, if necessary by tests, in such a way as not to approach a principal crystallographic direction of the specimen by less than about 3°.

The sensor C comprises a toroidal electrostatic sector which analyses the energy of the scattered ions. More precisely, the principal curvature of the toroidal electrostatic sector makes it possible to select the energy of the ions and its secondary curvature to focus them within an angular beamwidth of about 30° in order to bring them onto a pair of micro-channel plates of width 10 cm, polarized at 2×900V. The micro-channel plates convert each scattered ion into a pulse of electrons collected by an anode.

The electrical signals thus generated are converted into digital form and acquired by a data processing means (appropriately programmed computer) MT. The latter carries out the data processing, automatically or semi-automatically, and controls the goniometer G in order to carry out an azimuthal angle scanning and also the detector D in order to carry out an energy scanning.

An additional advantage of the method of the invention is that the microchannel plates are not disposed directly facing the specimen. Because of this, they are protected from the photons inevitably generated during the ions-specimen interaction and which are a large source of noise in the “3D-MEIS” technique.

The specimen E must be monocrystalline at least on the scale of the spot (typically included between 0.1 mm² and 0.5 mm²) formed by the beam of ions FI on its surface. Said specimen, or at least the portion of it which has to be characterized, must have a very small thickness, generally of less than 1 μm or even less than 100 nm. Typically, the specimen is constituted by layers of nanometric thickness or by nano-objects deposited on a homogeneous substrate which itself has a much greater thickness (500 μm-1 mm, or even greater) and can possibly serve as a reference.

For reasons which will be explained below, the method of the invention does not function correctly for greater thicknesses.

By way of example, FIG. 3 shows a cross-sectional view of a specimen E constituted by a substrate S made of Si upon which is deposited a first layer C₁ of SiGe of thickness 10 nm, then a second layer C₂ of sSi (Strained Silicon), of thickness 1.5 nm and, finally, a third layer C₃ of SiO₂. Only the first layer C₁ has to be characterized. It must be understood that the specimen does not necessarily have to be constituted by layers, that is to say of structures having a thickness of less than, by at least an order of magnitude, its two other dimensions. It can also be a nano-object, such as a quantum dot or a set of quantum dots, or even a bundle of nanowires provided that the latter are at least approximately aligned with each other. If the object to be characterized has lateral dimensions less than those of the bundle, it is preferable that the substrate is constituted by atoms lighter than said object, in order not to interfere with the measurement.

FIG. 2 shows the operating principle of the method of the invention. The beam FI is incident on a specimen E having a hexagonal mesh crystalline network characterized by crystalline parameters a and c, as shown in the figure. An ion of said beam collides (in fact interacts through an electrostatic force) with an atom A₁ of the crystalline network and is back-scattered. The angles θ_{d} and φ identify the direction of the ion after scattering. If this scattering direction corresponds (at least approximately) with a crystalline direction, the scattered ion will intercept another atom A₂ of the network and will be scattered again. The result is that no scattered ion can leave the crystal with a scattering direction corresponding to a crystalline direction. It can be considered that each atom of the network projects cones of shadow CO along the crystalline directions. By identifying the directions from which no scattered ions come it is therefore possible to determine the crystalline directions, and consequently the structure of the network.

The energy of the scattered ions also provides information. In fact all of the ions arrive on the specimen with the same energy; however, on passing through the specimen, they give up energy to the electrons of the crystal, in the form of volume plasmons. The longer the path within the crystal is, the greater is the loss of energy. Consequently, the energy of the scattered ions provides information on the depth at which the scattering took place. This is not entirely correct because the energy also depends on the scattering angle. This effect can be corrected for, or ignored.

Up until now it has implicitly been considered that all of the atoms of the crystal are of the same chemical species. In general, this is not the case. When an ion is scattered by an atom of a crystalline network, it gives up a fraction of its energy to said atom, the fraction becoming larger as the mass of the atom becomes lower. Thus, in the case of an SiGe specimen the ions scattered by the silicon atoms (atomic mass 28) will leave the crystal with a much lower energy than those scattered by the germanium atoms (atomic mass 72).

In concrete terms, a relatively crude energy filtering of the ions makes it possible to retain only the ions scattered by atoms of a specific chemical species. A finer filtering makes it possible to select the ions which have been scattered at a specific depth. This method of analysis does not operate if the depth of penetration of the ions and the thickness of the specimen are too large: in this case, for example, an ion scattered by a very deep germanium atom could have the same energy as an ion scattered by a silicon atom nearer the surface.

In comparison with the “3D-MEIS” technique, the better energy resolution makes it possible to discriminate chemical species having relatively close atomic masses.

In order to implement the method of the invention, the procedure is as follows.

The specimen E is placed in an oblique direction with respect to the incident beam of ions (or vice-versa) avoiding coming closer than three degrees to a principal crystallographic direction (45° for the direction [101] or 54° for [111]). The choice of the angular position of the detector depends on the crystalline directions that are to be studied.

The detector D is adjusted to a fixed energy (determined by adjustment of the potential of the toroidal electrostatic sector) corresponding to a chemical element and to a given depth. In order to calculate the desired energy, it is possible to use software simulating elastic scattering and available commercially, for example the SIMNRA software (http://www.rzg.mpg.de/˜mam/).

The source of ions is activated and the ions scattered within the beamwidth of the detector (for example 30°) with the selected energy are detected and counted.

The operation is then repeated after having carried out a small rotation (typically of less than 1°, for example 0.25°) of the specimen about an axis perpendicular to its surface. The azimuthal direction of the detected ions is thus changed. The operation must be carried out a sufficient number of times to cover an angular range representative of the symmetry of the crystal (at least 45° for a cubic crystal, at least 30° for a hexagonal crystal).

The number of ions sent onto the specimen must be the same for each elementary acquisition (that is to say for each azimuthal angle) and is quantified in terms of dose (for example 5 μCoulomb, the dose being defined as the integral of the current of ions received by the specimen over time).

Each elementary acquisition forms one line of a bidimensional image, of the type shown in FIG. 4. In this figure, the horizontal axis represents the scattering angle θ_{d}, the vertical axis represents the azimuthal angle φ and the shade of gray represents the number of ions detected (black: no detection; the lighter the gray, the greater the number of detected ions). The image shown in FIG. 4 corresponds to the layer C₁ of the specimen shown in FIG. 3, obtained using He⁺ ions of 100 keV with an angle of incidence of 48° and a detector placed at 90° with respect to the incident beam. The nominal angular beamwidth of the detector is 30°, but only the central 22° have been used in order to avoid artifacts present at the edges of the aperture. The detector is positioned in such a way as to collect the ions scattered in a plane defined by a slot of said detector and the direction of the incident beam. In the case of this example, the normal to the specimen is in this plane, but this is not essential.

In the image of FIG. 4 it is possible to observe:
Black horizontal lines LH, corresponding to an effect called ion channeling which is observed if the beam of incident ions is aligned with a crystalline plane of the specimen.
Black spots corresponding to principal crystalline directions (see the explanation given above with reference to FIG. 2). In particular, the spot T₁ at the center of the image corresponds to the direction [101] of a crystal with face-centered cubic symmetry, whilst the spot T₂ situated at −79 degrees horizontally and at −45 degrees vertically corresponds to the direction [111], these two directions being the principal directions of the cubic structure.
Curved lines LC which are in reality constituted by a multitude of small spots associated with high order crystalline directions.

Apart from the horizontal lines LH, FIG. 2 corresponds to a portion of the projection of the crystalline network of the specimen, at a given depth determined by the energy of the selected ions, onto a spherical surface defined by the detector D. This figure is entirely equivalent to a pole figure of the crystalline network, except that a conventional pole figure is a projection of the network onto a plane and not onto a spherical surface. Simple image processing would make it possible to convert FIG. 2 into a conventional pole figure.

Measuring the angular positions of the different crystalline directions on the image makes it possible to discover the symmetry and the possible deformations of the crystalline network at the selected depth. Thus, if the angle between two principal crystalline directions is not equal to the theoretically expected angle, it can be concluded that there is a deformation.

The aforesaid SARIS technique in its turn makes use of (low energy) ion scattering in order to determine pole figures. However, these figures contain information relating only to the structure of the surface of the specimen and, because of this, do not show all of the crystalline directions. Moreover, as explained above, their angular resolution is very inadequate for allowing a study of stresses in the specimen. Moreover, the SARIS technique comprises the acquisition of images all at once due to the use of bidimensional sensors, incompatible with energy filtering of scattered ions.

Contrary to the MEIS method, the method of the invention does not necessitate a reference measurement taken in the substrate S, because a deformation can be revealed simply by comparing two crystalline directions of the same object. Moreover, this method makes it possible to measure rotations of the crystal in all directions in space which, here again, is not possible with the conventional MEIS method.

It is also possible, and advantageous, to acquire several images corresponding to different ionic energies and therefore to different depths. In this way a “data cube” is obtained, representative of the three-dimensional crystalline structure of the specimen. Deformations of the crystalline network can be revealed by the fact that the position of the spots representative of the principal crystalline directions changes with the energy of the detected ions (and therefore with the depth).

This also makes it possible to correct the abovementioned dependence of the energy E₁ of the scattered ions on the scattering angle θ. In fact, it can be shown that the following equation is complied with:

$${E}_{1} = {{E}_{0} [ \frac{\sqrt{{M}_{1}^{2} - {m}^{2} {sin}^{2} θ} + m cos θ}{{M}_{1} + m} ]}^{2}$$

where E₀ is the energy of the primary ions, m is the mass of the ions and M₁ is the mass of the scattering centers (atoms of the specimen). The use of a data cube makes it possible to improve the depth resolution of the structural analysis method, which is above all useful for the characterization of objects of very small thickness (2-3 nm or even less).

The horizontal lines LH are also of interest. As mentioned above, these lines correspond to azimuthal angles in correspondence with which, the incident beam is aligned with the crystalline planes of the specimen. In these conditions an ion channeling effect occurs, which means that the number of ions scattered is substantially zero in all scattering directions. The angular separation between these lines provides the symmetry of the crystal directly in the case where this is unknown. Moreover, the azimuthal angle of one of these lines makes it possible to determine the orientation of the crystalline network in space and to do so with an accuracy of the order of 0.1°.

The method of the invention has been described with reference to a particular example, which is not limitative. In particular, other ion sources (radiofrequency sources or cylotronic resonance sources for example), or even atomic beams, as well as other types of detectors (for example surface barrier detectors) can be used.

### REFERENCES

[1] D. Jalabert, J. Coraux, H. Renevier, B. Daudin, M.-H. Cho, K. B. Chung, D. W. Moon, J. M. Llorens, N. Garro. A Cros and A. Garcia-Cristobal, Deformation profile in GaN quantum dots: Medium-energy ion scattering experiments and theoretical calculations, Phys. Rev. B 72, 115301 (2005).
[2] K. Sumitomo, H. Omi, Z. Zhang and T. Ogino, Phys. Rev. B, 67, 035319 (2003).
[3] S. Founta, J. Coraux, D. Jalabert, C. Bougerol, F. Rol, H. Mariette, H. Renevier, B. Daudin, R. A. Olivier, C. J. Humphreys, T. C. Q. Noakes, P. Bailey, Anisotropic strain relaxation in a-plane GaN quantum dots, J. Appl. Phys. 101, 063541 (2007).
[4] D. W. Moon et al., Direct measurements of strain profiles in Ge/Si(001) nanostructures, Appl. Phys. Lett. 83, 005298 (2003).
[5] T. C. Q. Noakes et al. Compositional and structural changes in i-AlPdMn quasicrystals induced by sputtering and annealing: A medium energy ion scattering study, Surface Science, Vol. 583, No 2-3, 1 Jun. 2005, pages 139-150.
[6] T. Kobayashi et al. Structural analysis of Er silicide nanowires on Si(001) using three-dimensional medium-energy ion scattering, Phys. Rev. B, Vol 75, No 12, 125401, 1 Mar. 2007.
[7] T. Kobayashi et al. Development of three-dimensional medium-energy ion scattering using a large solid angle detector, Nucl. Inst. & Methods in Physics Research, Sec. b, Vol 249, No 1-2, 1 Aug. 2006, pages 266-269.
[8] S. Susumu et al. Structure of an Er silicide nanowires on Si (001) using three-dimensional medium-energy ion scattering, J. Appl. Phys. Vol 96, No 6, 1 Jan. 2004, pages 3550-3552.
[9] Real-space surface crystallography: Experimental stereographic projections from ion scattering, Bolotin, I. L.; Houssiau, L.; Rabalais, J. W. Journal of Chemical Physics, Volume 112, Issue 16, pp 7181-7189 (2000).
[10] J. W. Rabelais, Temporal and spatial resolution of scattered and recoiled atoms for surface elemental and structural analysis, Surf. Interface Anal. 27, 171 (1999).

1. A method of characterizing a crystalline specimen comprising:
a. directing a substantially mono-energetic beam of projectiles chosen from atoms and ions onto a surface, called the top surface, of said specimen, the direction of propagation of said beam being characterized by an angle of incidence (θᵢ) and by a azimuthal angle (φ) measured in the plane of said surface, the energy of said projectiles being equal to or greater than 50 keV;
b. energy filtering the projectiles scattered by the specimen, detecting those of said projectiles that are scattered with a defined energy and measuring their scattering angle (θ_{d}), defined in a plane perpendicular to said top surface of the specimen;
c. repeating steps a and b for a plurality of different values of said azimuthal angle; and
d. constructing an image representative of the number of detected projectiles as a function of the scattering angle and of said azimuthal angle.

2. The method as claimed in claim 1, also comprising a step f consisting of determining at least two crystalline directions of the specimen by analyzing said image and in detecting a deformation of the crystalline network of said specimen from a comparison between said crystalline directions.

3. The method as claimed in claim 1, wherein said steps a to d are repeated for a plurality of different values of the ion scattering energy, a said image being constructed for each of said energy values.

4. The method as claimed in claim 3, also comprising a step f′ consisting of detecting a deformation of the crystalline network of said specimen from a comparison between said images corresponding to different energy values.

5. The method as claimed in claim 4, wherein at least one of said energy values corresponds to the energy of the ions scattered by a substrate of said specimen.

6. The method as claimed in claim 1, wherein said projectiles are chosen among: H⁺ ions and He⁺ ions.

7. The method as claimed in claim 1, wherein the energy of said projectiles is greater than or equal to 100 keV.

8. The method as claimed in claim 1, wherein the energy of said projectiles is included between 50 keV and 10 MeV and preferably between 100 keV and 3.5 MeV.

9. The method as claimed in claim 1, wherein said step b comprises the detection of the projectiles scattered in a range of scattering angles of width greater than or equal to 10°.

10. The method as claimed in claim 1, wherein said step c comprises the repetition of steps a and b for a plurality of different values of said azimuthal angle, distributed over a range of width greater than or equal to 30°.

11. The method as claimed in claim 1, wherein said specimen has a thickness of less than or equal to 1 μm.

12. The method as claimed in claim 11, wherein said specimen is deposited on a substrate of greater thickness.

13. The method as claimed in claim 1, wherein said specimen comprises at least one quantum dot, quantum wire or quantum well on a substrate.

14. The method as claimed in claim 1, also comprising a step of determination of a crystalline symmetry of said specimen by measuring the difference between the values of the azimuthal angle for which the number of detected projectiles is substantially zero for any scattering angle.

15. A computer program product specifically designed for implementing a method as claimed in claim 1.

16. The method as claimed in claim 9, wherein said step b comprises the detection of the projectiles scattered in a range of scattering angles of width greater than or equal to 20°.

17. The method as claimed in claim 11, wherein said specimen has a thickness of less than or equal to 100 nm.

18. The method as claimed in claim 11, wherein said specimen has a thickness of less than or equal to 20 nm.
